(19) United States
(12) Patent Application Publication
(10) Pub. No.: US 2011/0202547 A1
(43) Pub. Date: Aug. 18, 2011

(54) METHOD AND DEVICE ENABLING THE FUNCTIONAL EXPLOITATION, IN AN AIRCRAFT, OF A LARGE AMOUNT OF INFORMATION COMING FROM DIFFERENT SOURCES

(75) Inventor: Benoit MORIZET, Toulouse (FR)

(73) Assignee: AIRBUS OPERATIONS (S.A.S.), Toulouse (FR)

(21) Appl. No.: 13/010,375

(22) Filed: Jan. 20, 2011

(30) Foreign Application Priority Data
Feb. 15, 2010 (FR) 10 51056

(51) Int. Cl. G06F 17/30

(52) U.S. Cl. 707/758; 707/E17.014

(57) ABSTRACT

The invention has as an object the functional use, in an aircraft, of a great number of information items originating from different sources. The invention thus makes it possible to obtain information items originating from at least one information items group, the said information items obtained to be processed by at least one function called up in a system of the aircraft. After at least one information item has been identified and selected in the said at least one information items group according to at least one predetermined link combining a reference to the said at least one function called up with a reference to the said at least one information item, the said at least one information item is transmitted to the said at least one function called up.

This invention relates to the management of information items and more particularly to a method and a device allowing functional use, in an aircraft, of a great number of information items originating from different sources.

The display systems of modern aircraft make it possible to inform the crew members concerning the state of the aircraft. The information items generally are presented, on screens in the cockpit and/or in the cabin, in the form of messages, geographic images and synoptic diagrams representative of equipment items of the aircraft. These information items comprise data displayed continuously as well as data that may be displayed according to the flight phase in progress and the active alerts.

Furthermore, the crew members frequently use information items known as “mission” information items, provided in the form of paper documents updated regularly. These documents are, for example, the flight record with the dynamic facts of the day such as weather reports, and NOTAMs (acronym for Notice to Air Men in English terminology). Moreover, the airline companies may give their crews specific information items such as information items relating to navigation sectors, airports and routes.

These information items also may be provided on an electronic medium equipped with a screen separate from the screens allocated to the on-board instruments. The electronic medium generally is the reflection of the paper and the information is presented in an unchangeable format in which the information items cannot be selected individually.

Some modern aircraft, in particular A380 (A380 is a trade name) integrate so-called “en route” chart presentation systems in which the display is adapted to the zoom level used by filtering the information items.

In general, the fact of presenting the information items identically on paper and on screen facilitates the statutory proof for ensuring the segregation and non-corruption of information items.

Modern aircraft thus typically comprise two types of screens for concurrently presenting information items relating to official procedures and originating from the avionics. The result is use constraints linked to the fact that the information items are presented separately and that it is necessary to carry out verifications among the screens in particular in order to verify that the information items provided by the avionics are in accordance with the procedures presented on a different screen. Such constraints require the attention of the crew members, especially of the pilot and the copilot, who must make their way among several screens and among several types of information items.

Moreover, it is seen that the volume of mission information items generally is very considerable. These information items advantageously are organized in structured manner, according to dependency links, in order to facilitate the search for pertinent information items. Thus, for example, information items relating to airports are grouped in an “airport” structure, common to all the airports. In this structure there appear general information items such as the name of the airport, its position and the number of runways. An underlying “runway”-type structure may be used to store the information items relating to each runway, such as their name, their orientation and their length. However, although such a structure makes it possible to find information items easily, it nonetheless demands tedious search operations when it is a matter of applying it to a given flight because it is necessary to search successively for information items relating to some airports concerned in an “airports” documentation, then relating to the take-off procedure, the route followed and arrival and approach procedures.

The invention makes it possible to resolve at least one of the problems set forth above.

The invention thus has as an object a method for computer for obtaining information items originating from at least one information items group, the said information items obtained to be processed by at least one function called up in a system comprising the said computer, this method comprising the following steps,
identifying and selecting at least one information item in the said at least one information items group according to at least one predetermined link combining a reference to the said at least one function called up with a reference to the said at least one information item; and,
transmitting the said at least one selected information item to the said at least one function called up.

In this way the method according to the invention makes it possible to facilitate the task of the pilots by automatically performing a selection of information items, from different sources of information items, according to functions called up. It thus is possible in particular to directly use several types of information in the same geographic reference. The method makes it possible to extract information items from each source of information items flexibly on request and not as a set of information items usable only in consultation mode. The selected information items, for example of chart and avionic type, then may be displayed on the same screen.

According to a specific embodiment, the said step of selecting comprises a step of evaluating at least one attribute associated with the said at least one link, the said at least one information item being selected in response to the said step of evaluating the said at least one attribute. In this way the method according to the invention makes it possible to select, precisely and efficiently, the information items to be transmitted.

The said step of evaluating advantageously comprises a step of accessing at least one contextual datum so that the information items transmitted are at least partially selected contextually.

Still according to a specific embodiment, the said step of evaluating comprises a step of evaluating a logic rule. In this way it is possible to define the manner in which the transmitted information items are selected.

Advantageously, the said steps of selecting at least one information item and transmitting the said at least one selected information item are repeated if at least one parameter of the said at least one attribute varies. In this way the method according to the invention allows a dynamic selection of the transmitted information items according to attributes.

Still according to a specific embodiment, the said at least one link is stored in a reference table, the said reference table comprising predetermined links between references to functions that may be called up in the said system and references to information items of the said at least one information items group, the said step of selecting comprising a step of accessing the said reference table. The selection of the information items thus is simple to implement and the associated maintenance operations are facilitated.

The method preferably further comprises a step of selecting the said at least one information items group among a plurality of information items groups. Access and transfer of the information items thus are rapid.

The invention also has as an object a computer program comprising instructions adapted for the implementation of each of the steps of the method described above when the said program is run on a computer, a device comprising means adapted for the implementation of each of the steps of the method described above as well as an aircraft comprising such a device.

The advantages obtained with this computer program, this device and this aircraft are similar to those mentioned above.

Other advantages, purposes and characteristics of this invention become apparent from the detailed description that follows, presented by way of non-limitative example, with reference to the attached drawings in which:

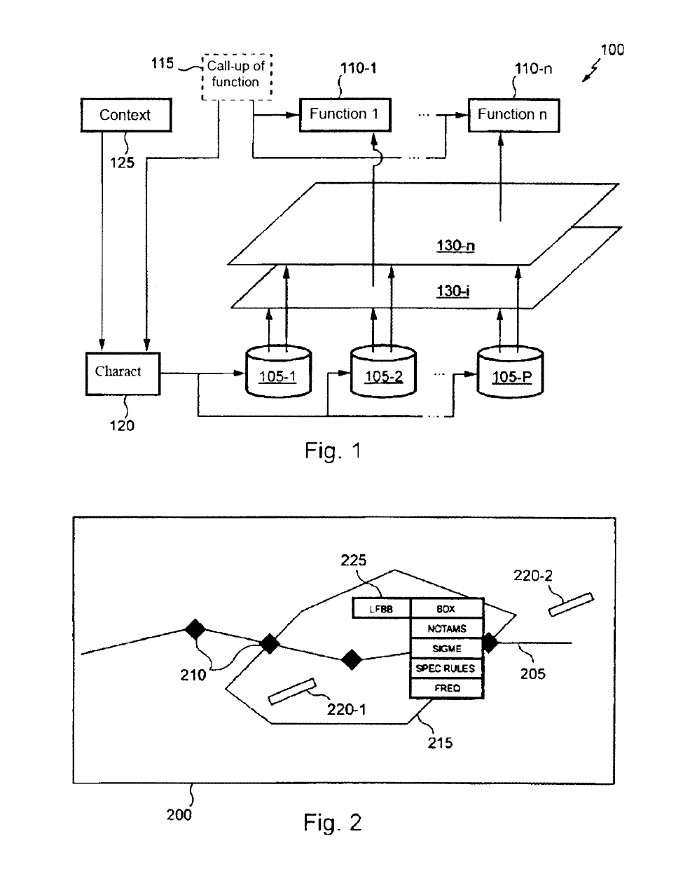

FIG. 1 schematically illustrates the general principle of the invention for identifying and obtaining information items to be processed by specific functions in the environment of an aircraft;

FIG. 2 shows exemplary information items displayed in an aircraft cockpit during call-up to a “route review”-type function implementing the invention;

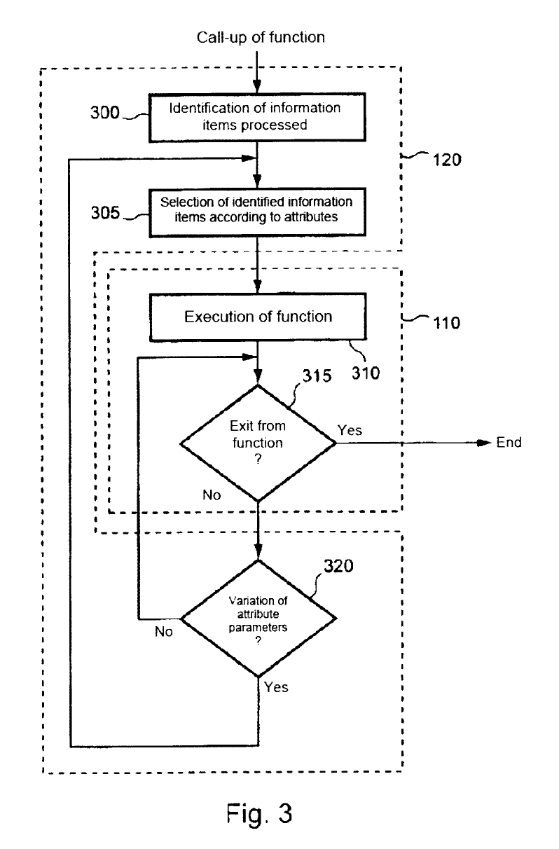

FIG. 3 illustrates certain steps implemented during call-up of a function in accordance with the invention;

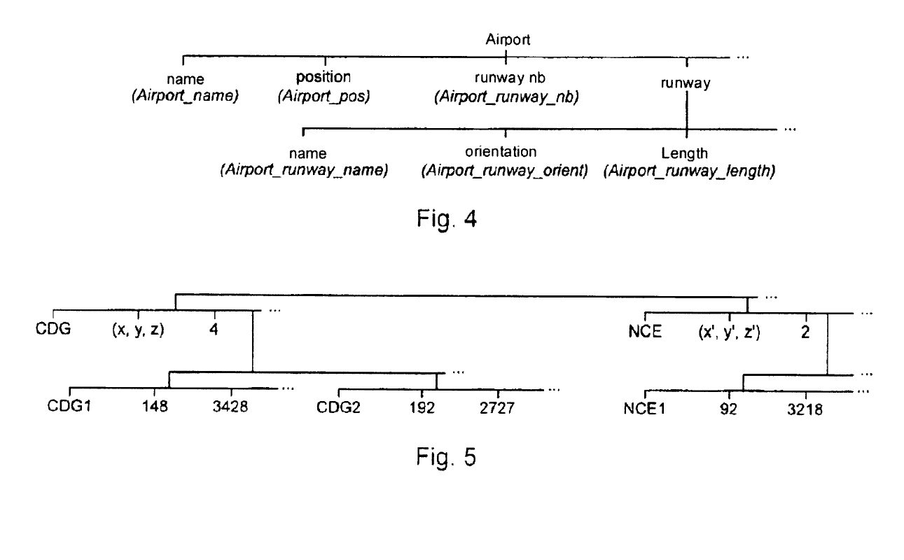

FIG. 4 schematically illustrates an exemplary hierarchical information-item structure that may be used to implement the invention;

FIG. 5 illustrates an exemplary extract from a database the data structure of which is similar to that illustrated on FIG. 4, that may be used to implement the invention; and,

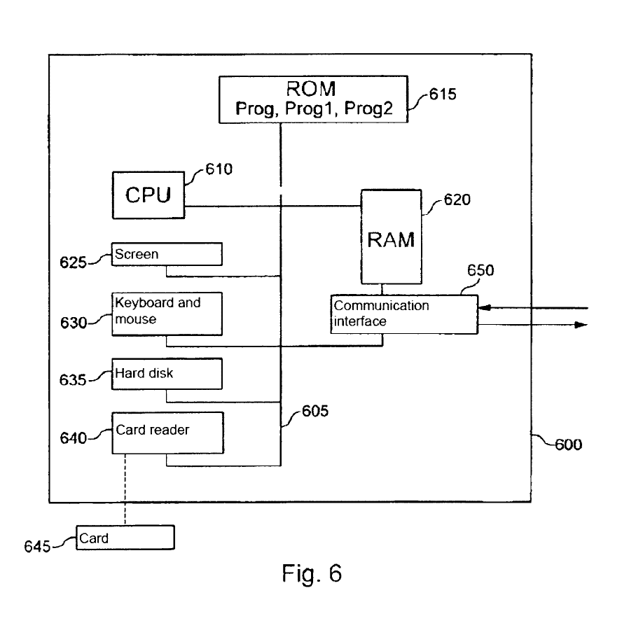

FIG. 6 illustrates an exemplary hardware architecture adapted for implementing the invention.

In general, the invention makes it possible to establish a link between information items originating from different sources and functions for bringing together information items to be processed and/or displayed according to an operational logic.

It is considered here that the different information items that may be processed have different origins and initially are brought together according to their origin.

Furthermore, each function, which may be activated by a crew member or automatically according to events, processes a given set of information items, not necessarily known to the function, potentially deriving from different sources.

According to a specific embodiment, links are defined between the information items and the functions, for each information item and each function, in the form of characteristics. In this way, for a specific information item, characteristics Cf1, Cf2, . . . , Cfn make it possible to identify this specific information item as a contributor or noncontributor to functions f1, f2, . . . , fn. These characteristics advantageously may be defined statically or variably according to a context, that is to say in accordance with an attribute. Thus, by combining a reference with a called-up function and data linked to a context, it is possible to identify specific information items that may be processed by the function called up.

FIG. 1 schematically illustrates the general principle of the invention for identifying and obtaining information items to be processed by specific functions in an environment 100 of an aircraft.

The information items accessible to the functions here are grouped in the form of information items groups 105-1 to 105-p corresponding, for example, to the sources of the information items. Thus, information item group 105-1 corresponds to a first information item origin, information item group 105-2 corresponds to a second information item origin and so on.

The information items of groups 105-1 to 105-p are stored in storage means of the aircraft such as hard disks of the avionic systems or in outside storage means connected to the aircraft, for example EFB (abbreviation for Electronic Flight Bag in English terminology), database servers or any other similar means.

Environment 100 further comprises functions 110-1 to 110-n which may process, in particular present in visual or audible form, information items groups 105-1 to 105-p. As shown by reference 115, these functions here are called up manually by a crew member or automatically according to events.

When a function is called up, there also is called up concurrently a characterization and extraction module 120 making it possible to extract information items from information items groups 105-1 to 105-p according to the function called up and, preferably, according to data linked to a context. Such data linked to the context may be obtained from several different systems, for example from an avionic system 125. By way of illustration, they may characterize the flight phase (parking, cruising, take-off/landing, climb/descent, taxiing), the geographic position or a state of the aircraft. These data linked to a context also may relate to other types of data available on board the aircraft, such as the date and the time.

The characterization and extraction module makes it possible, from a reference to the function called up and, possibly, from context data, to identify the information items from each information items group to be transmitted to the function called up. These identified information items here are shown in the form of virtual information item groups 130-1 and 130-n. Each virtual information items group here is associated with a function.

The information items groups are, for example, the following,
“charts” information group containing navigation charts used by the pilots;
“services” information group bringing together weather information items and conditions of the day. These information items in particular may be transmitted by services of the airline company operating the aircraft, on the ground; and,
“ground” information group bringing together information items relating to the ground not directly linked to a chart, in particular information items linked to the airports and their runways.

The functions using these information items are, for example, the following,
display functions such as the display of information items linked to the route, information items for briefing before take-off and information items for briefing before descent; and,
performance calculation functions.

The characteristics and extraction module is based, for example, on the use of reference tables such as those presented herewith (Table 1). As shown, each information item is identified by an identifier ID_Inf which is specific to the nature of the information item as well as by an identifier of the group ID_Grp to which it belongs. It should be noted that if, for needs of description, a table is defined here for each group, it also is possible to use a single table, the group identifier then being associated with each information item. Likewise, several tables may be associated with a single group.

Each variable may be associated with one or more functions identified by identifiers ID_Fct. The symbol ✓ here indicates that the information is to be transmitted to the function while the symbol x indicates that the information is not processed by the function and that it is not to be addressed thereto.

Each line of the links table here corresponds to an information item of the group considered while each column corresponds to a function. Thus, by way of illustration, the identified information item ID_Inf_2, relating, for example, to an airport name, is to be transmitted to the function ID_Fct_3, for example a display function, while the identified information item ID_Inf_4 is to be transmitted to the function ID_Fct_3.

As described above, each link between an information item and a function also may be associated with a context so that the link is activated only if the conditions linked to the context are verified. For these purposes, an attribute may be associated with each link between an information item and a function, instead of the validation indication for the link (✓ or x).

The attributes here are characteristics of the information items, linked to the user functions.

It is a matter, for example, of a minimal distance between a point or a set of points with which an information item is associated and the route of the aircraft. Thus, by way of illustration, information items may be used by a function only if they are linked to a sector crossed by the flight plan or if they are linked to points located at a distance less than a given distance of the flight plan. Likewise, information items may be used only if they relate to points located at a distance less than a given distance from the position of the aircraft. Thus, for example, information items relating to an airport will be used only if the aircraft is near the airport in question.

The attributes also may relate to data linked to procedures followed by the aircraft or to the type of aircraft in order to determine whether or not an information item is to be processed by a function. For example, information items may be used by a function only during the phases of take-off, approach or landing or be valid only for certain types of aircraft (for example, a runway too short for a given type of aircraft or according to the state of the aircraft will not be considered as valid).

Similarly, attributes may be of temporal nature. Thus, for example, information items relating to a NOTAM will be valid and therefore used by a function only during a determined time period linked to the validity period of the NOTAM.

The attributes also may relate to information items which the airline company operating the aircraft deems useful to communicate to its crews. It may be a matter, for example, of information on availability of accommodation near a given airport.

An attribute thus typically is a logic rule based on data specific to the aircraft or to its mission. These rules may comprise several elements combined with logic operations such as ‘AND’ and ‘OR.’

The attributes may be stored in the reference tables used.

By way of illustration, a reference table comprising attributes is presented herewith (table 2). This table is similar to table 1 described above and makes it possible to establish links between information items and functions. However, while table 1 comprises static links between the information items and the functions, the nature of the links here is static (that is to say permanent because of being independent of the context) or dynamic, the dynamic links depending on attributes, that is to say on the application of rules the result of which varies according to the context.

Thus, for example, the identified information item ID_Inf_1 never is used by the identified function ID_Fct_2 while the identified information item ID_Inf_n always is used by this function and the identified information items ID_Inf_4 and ID_Inf_i are or are not used by this function according to the value of attributes (1) and (2).

Attribute (1) here corresponds to the distance (dist) between the position of the aircraft (pos) and that linked to the identified information item ID_Inf_4 which must be less than one hundred miles and the flight phase (phase) that is to correspond to the approach. It is seen here that an information item such as the position linked to another information item generally may be obtained through the hierarchical organization of information items as described with reference to FIGS. 4 and 5.

Attribute (2) corresponds to the distance (dist) between the path followed by the aircraft (route) and that linked to the identified information item ID_Inf_i which must be less than ten miles. Similarly, the link between the identified information item ID_Inf_i and the identified function ID_Fct_3 exists only if this information items is of French (LF) origin (orig) and if the aircraft is of type (type) A, B, C or D (A/B/C/D). Likewise, the link between the identified information item ID_Inf_2 and the identified function ID_Fct_j exists only if this information item is valid (valid) in time or if the validity period has not been expired for more than an hour.

An example of use of these links between information items and functions is the implementation of the function known under the name of “route review” making it possible to display all the pertinent information items linked to a flight plan of an aircraft. These information items typically comprise the following,
the sectors overflown;
the information items connected to these sectors;
the crossing points of the sectors and boundaries; and,
the airports identified for a diversion.

The application of rules based on distances in relation to the route makes it possible to select the pertinent information items and to ignore the others which, however, are potentially usable by the function called up.

Such a list may be adapted as desired by the airline company that operates the aircraft by adding information items with the criteria already identified.

This function may be effectively supplemented by a visual highlighting of the elements to make them stand out in relation to the other information items.

FIG. 2 shows an example of information items displayed in an aircraft cockpit during the call-up of a “route review”-type function implementing the invention.

Display 200 here applies to route 205 of the aircraft comprising crossing points 210, or waypoints in English terminology, as well as a sector 215 to be overflown and airports 220-1 and 220-2 located near the flight path. Information items 225 relating to the sectors overflown are displayed here. In this example, it is a matter of information items relating to the airports belonging to the sectors overflown, that is to say to airport 215-1.

In this way, the use of dynamic links between the information items and the functions makes it possible to selectively access the pertinent information items in order to make the information items presented easier to read for the crew members since they are filtered consistently with an anticipated use.

In this way the characterization and extraction function makes it possible to identify the information items relating to the called-up function “route review” and to filter the non-pertinent information items according to the attributes of these information items.

Other functions may be called up in order to process and/or display information items deriving from different origins according to the characteristics of the aircraft and/or of its mission. In this way, for example, a briefing function may be used to display information items generally appearing on the charts used in order to select only those that actually correspond to the briefing of the aircraft concerned and to the flight plan studied.

The selective extractive function may be supplemented with a comparison function in order to emphasize the possible difference between the flight plan released in the charts and the one which the crew or the company provides to the navigation system.

Similarly, a set of information items to be used in flight and to be displayed continuously may be defined for a monitoring function in order to display a mapping of the safe altitudes, the minima of overshooting in approach phase and the information items for look-ahead to degraded situations, for example if there is a loss of landing capability during flight or change in the procedure to be followed.

FIG. 3 illustrates more precisely the steps implemented during the call-up of a function. As illustrated, a first step has as an object to identify the information items processed by the function called up (step 300). This identification may be accomplished via a reference table such as those provided herewith. This step makes it possible to identify all the information items that potentially may be processed by the called-up function, that is to say the information items identified by static links as well as all the information items identified by dynamic links.

A following step applies to the selection of the identified information items (step 305). During this step, all the information items defined by static links are selected as well as all the information items the attributes of which are verified. For these purposes, the attributes are evaluated in particular by using context data.

The called-up function then is executed (step 310) with the selected information items that are processed and/or displayed according to the function.

In a following step, a test is performed in order to determine whether the execution of the function is stopped (step 315). If so, the algorithm is ended. Otherwise, another test is performed in order to determine whether the parameters of the attributes of the identified information items have varied (step 320). If not, the algorithm ends on the preceding step (315). If, on the contrary, the parameters of the attributes of the identified information items have varied, the preceding steps (steps 305 to 315) are repeated in order to select the information items to be processed by the called-up function.

It is seen here that, in accordance with FIG. 1, steps 300, 305 and 320 are implemented in characterization and extraction module 120 while steps 310 and 315 are implemented in the “function” module generically referenced 110.

FIG. 4 schematically illustrates an exemplary hierarchical structure of information items, linked to an airport, which may be used to implement the invention. The names in parentheses here are identifiers of information items that may be processed and/or displayed by a function.

According to this example, the information items relating to an airport are, in particular, its name (Airport_name), its position (Airport_pos) and the number of runways (Airport_runway_nb). For each of these runways, the information items are, in particular, their name (Airport_runway_name), their orientation (Airport_runway_orient) and their length (Airport_runway_length).

FIG. 5 illustrates an exemplary extract from a database relating to airports, for example belonging to an information items group relating to airports, the data structure of which is similar to that illustrated on FIG. 4, which may be used in order to implement the invention. This example applies to two airports, CDG and NCE, more than 200 miles apart.

Airport CDG here is located at position (x, y, z) and comprises 4 runways. The first runway is called CDG1, it is oriented at 148° and measures 3,428 meters, while the second is called CDG2, is oriented at 192° and measures 2,727 meters. Airport NCE here is located at position (x′, y′, z′) and comprises 2 runways the first runway of which is called NCE1. It is oriented at 92° and measures 3,218 meters.

By way of illustration, if a function F needs to display the lengths of runways located less than 100 miles from the aircraft, a reference table must comprise an attribute of “dist(pos)<100 miles”-type linking the function F to the identifier Airport_runway_length. The lengths of all the runways stored then are identified, that is to say here the lengths 3,428, 2,727 and 3,218 of the runways CDG1, CDG2 and NCE1 of the airports CDG and NCE. The selection then is made by comparing the position of the aircraft with that of the places associated with the identified information items, that is to say with that of the airports CDG and NCE, and a threshold of 100 miles. These positions are identified by the predetermined and known structure of the information items. In this way, if the aircraft is less than 100 miles from NCE (therefore necessarily more than 100 miles from CDG), only the length 3,218 corresponding to the runway NCE1 of the airport NCE is displayed.

FIG. 6 illustrates an exemplary hardware architecture, of on-board computer type, adapted for implementing the invention, in particular the algorithm shown on FIG. 3. Device 600 here comprises a communication bus 605 to which there are connected:
one or more central processing units or microprocessors 610 (CPU, abbreviation for Central Processing Unit in English terminology);
a read-only memory 615 (ROM, acronym for Read Only Memory in English terminology) that can comprise the programs (prog, prog1 and prog2) necessary for implementation of the invention;
a random access or cache memory 620 (RAM, acronym for Random Access Memory in English terminology) comprising registers adapted for recording variables and parameters created and modified in the course of running the aforesaid programs; and
a communication interface 650 adapted for transmitting and receiving data.

Device 600 also preferably has the following components:
one or more display units 625 making it possible to display data such as identified and selected information items and able to serve as graphical interface with the user who will be able to interact with the programs according to the invention, with the aid of a keyboard and a mouse 630 or another pointing device such as a touch screen or a remote control;
a hard disk 635 that can comprise the aforesaid programs, information items to be processed according to the invention and reference tables; and
a memory card reader 640 adapted for receiving a memory card 645 and reading or writing therein data processed or to be processed according to the invention.

The communication bus permits communication and interoperability among the various components included in device 600 or connected thereto. The depiction of the bus is not limitative and, in particular, the central unit is able to communicate instructions to any component of device 600 directly or through another component of device 600.

The executable code of each program permitting the programmable device to implement the processes according to the invention may be stored, for example, on hard disk 635 or in read-only memory 615.

According to a variant, memory card 645 may contain information items, in particular information items to be processed according to the invention and reference tables, as well as the executable code of the aforesaid programs which, once read by device 600, is stored on hard disk 635.

According to another variant, the executable code of the programs, the information items to be processed according to the invention and/or the reference tables will be able to be received, at least partially, via interface 650, to be stored in a manner identical to that described above.

More generally, the program or programs as well as the information items to be processed according to the invention and/or the reference tables will be able to be loaded into one of the storage means of device 600 before being run.

Central unit 610 is going to control and direct the execution of the instructions or portions of software code of the program or programs according to the invention, which instructions are stored on hard disk 635 or in read-only memory 615 or else in the other aforesaid storage components. During boot-up, the program or programs that are stored in a non-volatile memory, for example hard disk 635 or read-only memory 615, are transferred to random access memory 620 which then contains the executable code of the program or programs according to the invention, as well as the registers for storing the variables and parameters necessary for implementation of the invention.

It should be noted that the memory used for storing the data may be integrated into a database server. Likewise, accessibility to the data according to the functions implemented may be accomplished via a multiplexed bus.

Naturally, in order to satisfy specific needs, an individual competent in the field of the invention will be able to apply modifications in the foregoing description. In particular, although the invention has been more specifically presented in the field of aircraft, it should be noted that more generally it may be implemented in many similar technical fields, in particular in automotive vehicles and boats.

### Attachment

TABLE 1
ID_Grp = ID_Grp_1

| | ID_Fct | | | | | | |
|---|---|---|---|---|---|---|---|
| ID_Inf | ID_Fct_1 | ID_Fct_2 | ID_Fct_3 | . . . | ID_Fct_j | . . . | ID_Fct_m |
| ID_Inf_1 | x | x | x | | x | | ✓ |
| ID_Inf_2 | ✓ | x | ✓ | | x | | ✓ |
| ID_Inf_4 | x | ✓ | x | | x | | ✓ |
| . . . | | | | | | | |
| ID_Inf_i | x | ✓ | ✓ | | ✓ | | x |
| . . . | | | | | | | |
| ID_Inf_n | ✓ | ✓ | X | | ✓ | | ✓ |

TABLE 2
ID_Grp = ID_Grp_3

| | ID_Fct | | | | | | |
|---|---|---|---|---|---|---|---|
| ID_Inf | ID_Fct_1 | ID_Fct_2 | ID_Fct_3 | . . . | ID_Fct_j | . . . | ID_Fct_m |
| ID_Inf_1 | x | x | x | | x | | ✓ |
| ID_Inf_2 | ✓ | x | ✓ | | (4) | | ✓ |
| ID_Inf_4 | x | (1) | x | | x | | ✓ |
| . . . | | | | | | | |
| ID_Inf_i | x | (2) | (3) | | ✓ | | x |
| . . . | | | | | | | |
| ID_Inf_n | ✓ | ✓ | x | | ✓ | | ✓ |

(1): dist(pos) <100 miles AND (phase) = approach
(2): dist(route) <10 miles
(3): (orig) = LF AND (type) = A/B/C/D
(4): (valid) OR (valid)-time_current <1 h

1. Method for computer for obtaining information items originating from at least one information items group, the said information items obtained to be processed by at least one function called up in a system comprising the said computer, this method being characterized in that it comprises the following steps,
identifying (300) and selecting (305) at least one information item in the said at least one information items group according to at least one predetermined link combining a reference to the said at least one function called up with a reference to the said at least one information item; and
transmitting the said at least one selected information item to the said at least one function called up.

2. Method according to claim 1, according to which the said step of selecting comprises a step of evaluating at least one attribute associated with the said at least one link, the said at least one information item being selected in response to the said step of evaluating the said at least one attribute.

3. Method according to the preceding claim, according to which the said step of evaluating comprises a step of accessing at least one contextual datum.

4. Method according to claim 2 or claim 3, according to which the said step of evaluating comprises a step of evaluating a logic rule.

5. Method according to any one of claims 2 to 4, according to which the said steps of selecting at least one information item and transmitting the said at least one selected information item are repeated (320) if at least one parameter of the said at least one attribute varies.

6. Method according to any one of the preceding claims, according to which at least one link is stored in a reference table, the said reference table comprising predetermined links between references to functions that may be called up in the said system and references to information items of the said at least one information items group, the said step of selecting comprising a step of accessing the said reference table.

7. Method according to any one of the preceding claims, further comprising a step of selecting the said at least one information items group among a plurality of information items groups.

8. Computer program comprising instructions adapted for the implementation of each of the steps of the method according to any one of the preceding claims when the said program is run on a computer.

9. Device comprising mean adapted for the implementation of each of the steps of the method according to any one of claims 1 to 8.

10. Aircraft comprising the device according to the preceding claim.
